(19) United States
(12) Patent Application Publication
(10) Pub. No.: US 2023/0006898 A1
(43) Pub. Date: Jan. 5, 2023

(54) A Method of Capturing Packets from a Container in a Cluster

(71) Applicant: Siemens Aktiengesellschaft, Muenchen (DE)

(72) Inventor: Harald ALBRECHT, Nuernberg (DE)

(21) Appl. No.: 17/779,770

(22) PCT Filed: Nov. 28, 2019
(86) PCT No.: PCT/EP2019/082894

§ 371 Date: May 25, 2022

(51) Int. Cl. H04L 43/04; H04L 43/12; H04L 45/00; H04L 45/02

(52) U.S. Cl. CPC H04L 43/04; H04L 43/12; H04L 45/46; H04L 45/02

(57) ABSTRACT

A method for capturing packets originating from a first container from a cluster of containers that each container includes at least one network interface for transmitting packets, wherein the method includes detecting a first connection for transmission of packets from a first network interface associated with a first container and injecting container information of the first container in a packet stream associated with the first connection, where the injected container information serves for identification of the first container by a packet capture tool configured to capture the packet stream associated with the first connection.

### CROSS-REFERENCE TO RELATED APPLICATIONS

This is a U.S. national stage of application No. PCT/EP2019/082894 filed 28 Nov. 2019.

### BACKGROUND OF THE INVENTION

### 1. Field of the Invention

The current disclosure relates to containers in industrial automation and, more particularly, relates to packet capture and analysis of network traffic in relation to containers, where a packet capture tool (also known as a packet sniffer or packet analyzer) is a program or special hardware that is capable of intercepting and logging packets that are transmitted in a network, and where the packets are then used to analyze network behavior to improve network performance.

### 2. Description of the Related Art

The current disclosure relates to packet capture and analysis in industrial networks. With the advent of container technology, containers have been deployed in a plurality of environments including industrial automation. Accordingly, in addition to a multitude of physical assets, there are a large number of virtual participants in automation networks. These virtual participants or industrial applications are deployed and executed in huge numbers, because they are container based and are rather small and nimble. These industrial applications may run in the industrial plant on industrial Edges or may be executed on industrial OT clusters, having direct network access to the production network of the plant.

Accordingly, given the large number of participants (both physical and virtual) in the automation network, it becomes necessary to perform network analysis to ensure network utilization is optimal. In order to perform network analysis, packets in the network are recorded for analysis. This is achieved by packet capture tools, such as TCPdump, and/or Dumpcap. As a part of packet capture, in addition to the packets, certain metadata in relation to the packets such as network interface from which the packet is transmitted, name of the operating system, and/or version of the hardware, is recorded along with the corresponding packet.

However, the abovementioned industrial applications are not applications found directly in a host or virtual machine (VM), but rather containers that form an intermediate layer within a host or virtual machine. As a result, metadata from packet capture is often not sufficiently useful. A plurality of containers may share the same network interface name and, accordingly, merely recording network interface name does not provide sufficient indication regarding the origin of the packet. Accordingly, there is a need for a method and system for addressing the above-mentioned aspects.

### SUMMARY OF THE INVENTION

Accordingly, it is an object of the current disclosure to provide a method for capturing packets originating from a first container from a cluster of containers. Each container comprises one or more network interfaces for transmitting packets. The method comprises detecting a first connection for transmission of packets from a first network interface associated with a first container; and injecting container information of the first container in a packet stream associated with the first connection. The injected container information serves to provide identification of the first container by a packet capture tool configured to capture the packet stream associated with the first connection.

Accordingly, the current method allows for captured packets to be easily correlated with the containers in the cluster. This is particularly advantageous in being able to create a way for existing analysis tools to become ‘container-aware’. Additionally, ‘Capture as a Service’ can be realized and the acquisition of packets in the cluster can be made possible from using standard packet capture tools. Moreover, existing containers or pods do not need to be specially adjusted or restarted to enable packet capture.

In an example, the container information is determined based on one or more of a network identifier of the first network interface and a container catalogue. The container catalogue comprises container information of one or more containers. Container information of a container comprises a container identifier of the container and one or more network identifiers of corresponding one or more network interfaces of the container. Accordingly, based on the identifier of the network interface, the container information is determined. Consequently, this provides a non-intrusive manner of determining container information without modifying container deployment.

In an example, the network identifier of the first network interface includes one or more of a network namespace identifier, process identifier of a process associated with the first container, media access control (MAC) identifier, and identifier associated with a IP stack of the network interface.

In another example, the container catalogue is generated by a cluster discovery service. The cluster discovery service includes a plurality of node discovery modules, each discovery module hosted on a corresponding node for discovering container and network interface information associated with the corresponding node. Accordingly, cluster discovery service allows for discovery of containers and network interfaces along with their association to containers in an automated manner.

In another example, injecting container information further comprises identifying a first section header block in the packet stream associated with the first connection and appending the container information of the first container in a comment section of the first section header block. Accordingly, the container information is embedded in the section header block which could be understood by users and by packet capture applications.

In a further example, the first network interface is monitored by a capture client associated with the cluster. This allows for automated monitoring of network interfaces, detection of connections and capture of packets on the network interfaces.

It is also an object of the current disclosure to provide a system for capturing packets from one or more containers in a cluster of containers. The system comprises a cluster discovery service hosted in the cluster of containers, where the cluster discovery service is configured to discover the one or more containers in the cluster and generate a container catalogue. The system also includes a capture client hosted in the cluster of containers, configured to transmit plurality of packets associated with the one or more containers in the cluster, and further includes a data injector configured to receive plurality of packets from the capture client and inject container information of the corresponding container into one or more packets, based on the container catalogue, and a packet capture tool configured to record the plurality of packets, where the packet capture tool is configured to identify the corresponding container based on the injected container information from the one or more packets from the packet stream.

It is also an object of the current to provide a non-transitory storage medium for capturing packets originating from a first container from a cluster of containers. Each container comprises one or more network interfaces for transmitting packets. The non-transitory storage medium has a plurality of machine-readable instructions stored therein which, when executed by one or more processors, cause the one or more processors to detect a first connection for transmission of packets from a first network interface associated with the first container, and inject container information of the first container in a packet stream associated with the first connection, where the injected container information is for identification of the first container by a packet capture tool configured to capture the packet stream associated with the first connection.

Additionally, the current application incorporates by the reference in its entirety the details set forth in EP application 19204976.5 filed on 24 Oct. 2019 belonging to the current applicant.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The following detailed description references the figures, in which:

FIG. 1 illustrates an exemplary section of an example industrial network for capturing packets from a container in a cluster in accordance with the invention;

FIG. 2 illustrates an exemplary method for capturing packets from a container in a cluster in accordance with the invention;

FIG. 3 illustrates an exemplary cluster configuration in an industrial network in accordance with the invention;

FIG. 4 illustrates an exemplary method for generating and transmitting a container catalogue to a data injector in accordance with the invention;

FIG. 5 illustrates an exemplary method for capturing and transmitting packets to a data injector in accordance with the invention;

FIG. 6 illustrates another exemplary packet stream and modified packet stream in accordance with the invention; and

FIG. 7 illustrates an exemplary data injector device for capturing packets from a container in a cluster in accordance with the invention.

### DETAILED DESCRIPTION OF THE EXEMPLARY EMBODIMENT

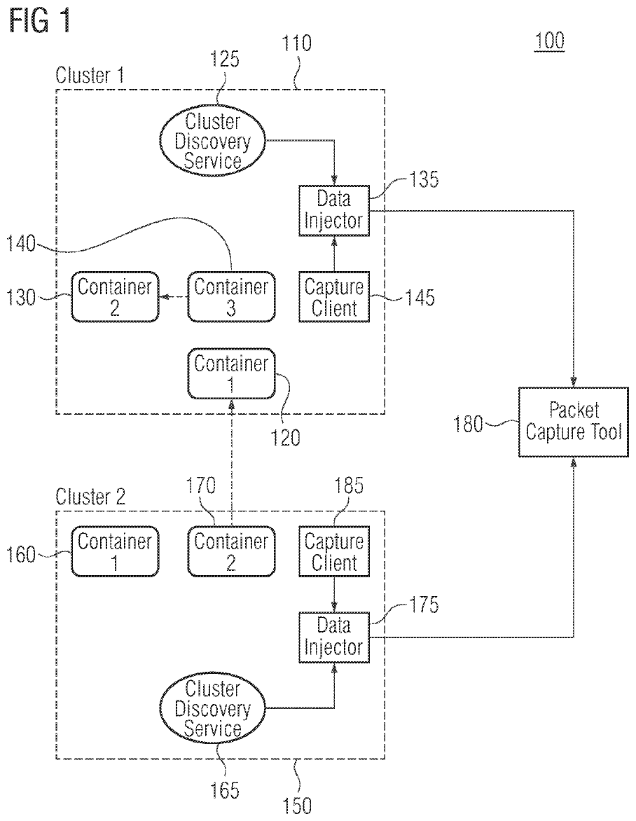

FIG. 1 illustrates a plurality of clusters (110, 150) in an industrial network 100 in an industrial facility (also referred to as an industrial plant). Industrial facility herein refers to any environment in which one or more industrial processes such as manufacturing, refining, smelting, assembly of equipment may occur and includes process plants, oil refineries, and/or automobile factories. The industrial facility may comprise a plurality of control devices connected to a plurality of field devices for monitoring and regulating one or more industrial processes in the industrial facility. Industrial network herein refers to any electronic data network and accordingly includes office campus networks, industrial automation networks, private radio networks, and any other networks. Each cluster is capable of analyzing and processing industrial data from one or more industrial data sources (i.e., field devices and control devices). Each cluster (110, 150) includes a plurality of physical and virtual nodes (also known as work nodes or nodes) upon which a plurality of containers (120, 130, 140, 160, 170) are hosted.

For example, a work node or node of a cluster might be a (separate) device or a (separate) hardware component. In another example, a work node is available as a “virtual node”, for example, a virtual machine executed on a device such as a PC, server or a computational platform. In yet another example, a work node can also be hosted on an automation component, such as a control device, and/or gateway device. Particularly preferably, at least one work node is an edge device, especially an industrial edge device. An edge device is in particular a device that performs one or more functions associated with edge computing. For example, an industrial edge device might be provided by an industrial computer, a gateway device, or an industrial server that performs an edge computing function. A cluster can also include different types of work nodes, such as at least one edge device and at least one virtual machine.

Each container (120, 130, 140, 160, 170) is configured to execute one or more related industrial applications for processing the abovementioned industrial data. Containers (also referred to as application containers) herein refers to runtime environments that can run independently, no matter where they are deployed. In contrast to virtual machines that represent an entire computing environment, the containers typically contain only the important libraries, files and other resources needed to run the application. Container contains software or application to be executed and resources needed to execute the same. Containerised applications can be easily and conveniently deployed in modular fashion.

For example, as shown in FIG. 1, the cluster 110 includes containers 120, 130 and 140. A plurality of industrial applications are hosted on the containers 120, 130 and 140. Similarly, the cluster 150 includes two containers: container 160 and container 170. A plurality of industrial applications are hosted on the containers 160 and 170. The applications on the containers are capable of communicating with other applications within the same cluster and across different clusters.

Additionally, a packet capture framework is present in the industrial network 100. The packet capture framework includes a plurality of capture clients (145, 185), cluster discovery services (also referred to service instances) (125, 165) and a packet capture tool (180). Each capture client (145, 185) and cluster discovery service (125, 165) is located with a corresponding cluster (110, 150). For example, as shown in FIG. 1, the capture client 145 and cluster discovery service 125 are hosted in cluster 110. Similarly, the capture client 185 and cluster discovery service 165 are hosted in cluster 150.

The cluster discovery service (125, 165) is hosted in the corresponding cluster (110, 150) and is responsible for discovering the containers and corresponding container configuration in the corresponding cluster (110, 150). The cluster discovery service (125, 165) discovers network interfaces of each node of the corresponding cluster and containers that exist on the respective node. Additionally, if containers are present, then the cluster discovery service determines associations between the containers of the respective node and network interfaces of the respective node. The capture client (145, 185) is hosted in the corresponding cluster (110, 150) and is responsible for monitoring communication and duplicating packets transmitted from and to containers, for recording the packets. The capture client transmits the duplicated or captured packets to the packet capture tool 180. The packet capture tool 180 records the duplicated packets which are then used for network analysis.

Additionally, the packet capture framework includes one or more data injectors (135, 175). In an example, the data injector acts as an intermediary between the capture client (145, 185) and the packet capture tool (180). In another example, the data injector (135, 175) is hosted within the corresponding cluster (110, 150). In further example, a data injector is hosted on a separate device and connected to the plurality of clusters (110, 150). The data injector receives the duplicated packets from the capture client and injects container information of the container associated with the packets, into a section of one or more packets. The injected information is used by the packet capture tool 180 to identify the container from which the packets originate.

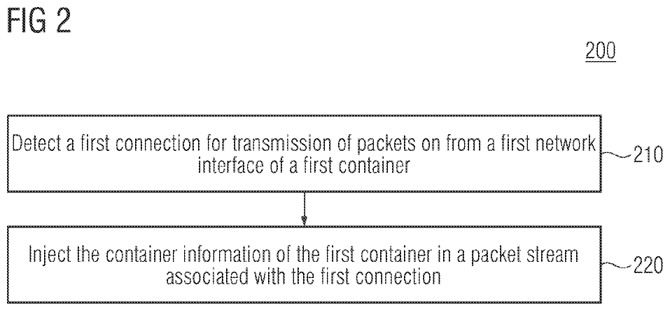

FIG. 2 illustrates a method 200 for capturing packets from a container in a cluster. The method 200 is explained in relation to data injector 135. In the example, a communication is initiated between an application on container 140 and an application on container 130. Accordingly, a connection (also referred to as first connection) is established between a first network interface associated with container 140 and a second network interface associated with the container 130. Packets are then transmitted from the container 140 (also referred to as first container 140) to the container 130. In the example, the method 200 is executed by the data injector 135 for capturing packets associated with the abovementioned communication between container 140 and 130 in coordination with the packet capture tool 180. While the method 200 is explained in relation to communication between containers 140 and 130, the current disclosure is applicable to communication amongst containers on different clusters as well. For example, communication between container 120 (on cluster 110) and container 170 (on cluster 150) can also be captured in accordance with the method 200.

At step 210, the data injector 135 detects the first connection for transmission of packets from the first network interface associated with the first container 140 in the cluster 110. In an example, the data injector 135 detects the first connection in coordination with the capture client 145 in the cluster 110.

The capture client 145 is configured to monitor a plurality of network interfaces within the cluster 110 and accordingly detects any connections established on a network interface from the plurality of network interfaces of the cluster 110. The capture client 145 then intimates or informs the data injector 135. In an example, the data injector 135 receives a network identifier of the first network interface on which the first connection is detected, from the capture client 145.

At step 220, the data injector 135 next injects container information of the first container 140 in a packet stream associated with the first connection. Packet stream relates to a sequence of data packets (also referred to as packets) transmitted from a source to destination. In an example, the data injector 135 determines the container information based on a container catalogue and the network identifier associated with the first network interface. The container catalogue is generated by the cluster discovery service (125, 165) hosted in the corresponding cluster (110, 150). Each cluster (110, 150) is equipped with a cluster discovery service (125, 165) which, so to speak, provides the corresponding data injector (135, 175) with an understanding of containers and their relation to network interfaces and other network resources, such as IP stacks (virtual and actual).

In a preferred embodiment, the cluster discovery service (also referred to as cluster acquisition module) is connected to a plurality of node discovery modules located on each node of the corresponding cluster.

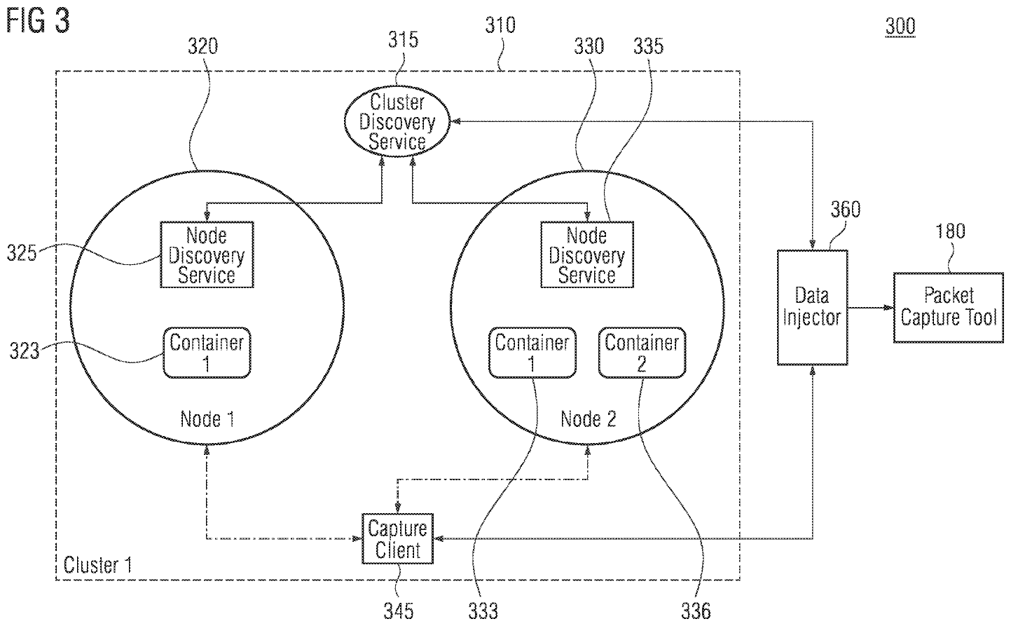

FIG. 3 illustrates an example cluster 310 configuration in the industrial network. The exemplary cluster 310 includes work nodes 320 and 330. The work node 320 includes container 323 and work node 330 includes containers 333 and 336. A capture client 345 is connected to the nodes 320 and 330 for capturing packets from the containers on the nodes 320 and 330. The capture client is connected to the data injector 360 for transmitting captured packets to the packet capture tool 180.

Additionally, the cluster 310 includes the cluster discovery service 315. The cluster discovery service 315 is connected to node discovery module 325 on the node 320 and node discovery module 335 on the node 330. Each node discovery module (325, 335) is configured to discover the network resources present on the corresponding node (320, 330), such as IP stacks, their network interfaces, and the containers present on the nodes. In other words, each node discovery module (325, 335) determines which containers are present on the node (320, 330), which network stacks the respective node has, which network interfaces are associated with the network stacks of the respective node and which container is associated with which network stack of the respective node.

In an embodiment, the network stacks (also referred to as networking stacks, IP stacks or protocol stacks) of the respective node are captured by the node discovery module (325, 335) of the respective node (320, 330) based on one or the process table of the operating system of the respective node (320, 330). Similarly, in an example, the node discovery module of the respective node determines network stack of the respective node, by currently reading active mounts (in particular “/proc/$PID/mountinfo”) of the operating system of the respective node. In an embodiment, the (respective) node discovery module searches the network namespaces used by processes, in particular by checking all references in “/proc/$PID/ns/net” for network stacks. Here, $PID is replaced in turn by all PIDs of the currently running processes.

In an example, in order to identify or capture the containers on a node, the (corresponding) node discovery module can contact the container engine associated with that node.

Container engines (such as dockers, for example) are typically used to manage the containers, such as downloading the required container images and starting and stopping them. Additionally, the process identifiers (PIDs) belonging to the containers are also determined along with names belonging to the containers, in particular names used by the container engine, which the container has from an applicative point of view and/or user-side.

Then, for each captured container, the node discovery module determines the network stack used by the container based on of the process table of the operating system (in particular via “/proc/$PID/ns/net”). It should be noted that the process identifiers (PIDs) of the container are used here. This means that the respective network interfaces are also known for the containers that are captured. It is known which container/pod is assigned to which network stack, and which network interfaces belong to which network stack. Consequently, it is also known which network interface(s) belongs to which container/pod or belong.

Subsequent to the discovery of the containers and the related network resources (interfaces, and/or stacks), the node discovery module (325, 335) transmits the information regarding the containers and the related network resources to the cluster discovery service 315. In an example, the node discovery module (325, 335) transmits the information in a form of the JSON data structure as shown below:

```
HTTP/1.1 200 OK
Content-Type: application/json
{
  “targets”: [
    {
      “name”: “containerx”,
      “ipstack”: “4026532600”,
      “network-interfaces”: [
        “eth2”,
        “mLAN”,
        “Nice stay”
      ] ,
      “path”: “”,
      “pid” : 42,
      “type”: “container”
    },
    . . .
  }
}
```

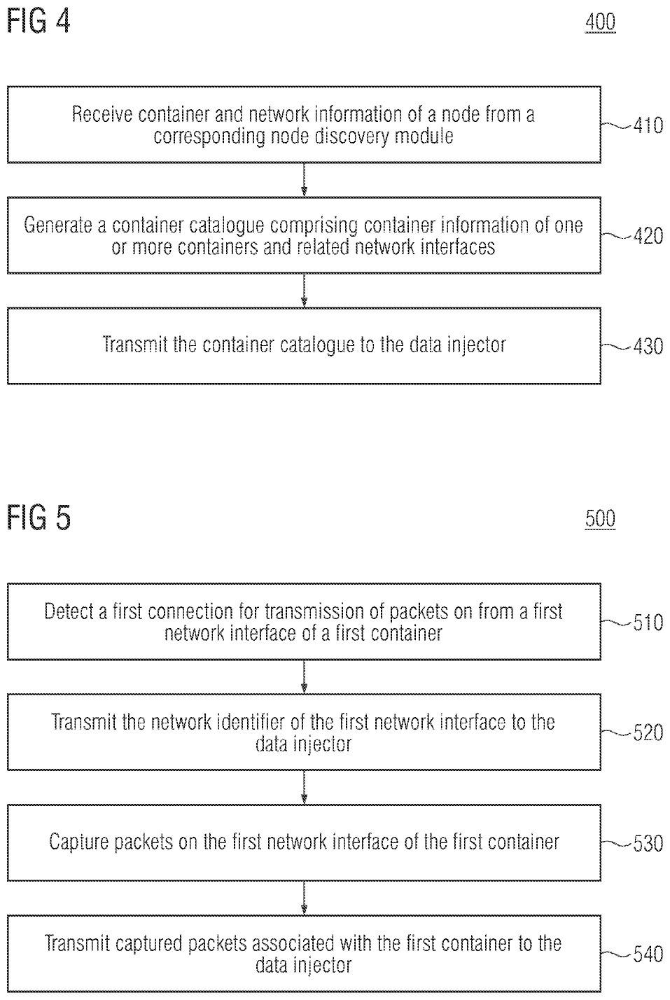

The cluster discovery service 315 receives the information from all the node discovery modules (325, 335) and generates the container catalogue of the corresponding cluster 310. This is explained further in reference to FIG. 4.

FIG. 4 illustrates an exemplary method 400 for generating and transmitting a container catalogue by the cluster discovery service 315 to the data injector 360. At step 410, the cluster discovery service 315 receives container and network interface information from all the node discovery modules (325, 335), as mentioned above. At step 420, based on the same, the cluster discovery service 315 then generates the container catalogue. The container catalogue contains the names of all containers and related identifiers (IDs) on the cluster 310, present node numbers of the respective assigned (virtual or actual) network stacks, the names of the corresponding network interfaces and a reference to the respective node discovery module, such as in the form of an IP address. At step 430, the cluster discovery service 315 then transmits the container catalogue to the data injector 360. Based on the container catalogue, the data injector 360 can determine the identifier of container based on the identifier of the related network stack or network interface, which is assigned to at least one container.

Accordingly, in addition to the determination of the container information, the data injector 135 receives packets from the capture client 145. Continuing the above-mentioned example, data packets of the first container 140 (transmitted to the container 130) is captured by the capture client 145 on the cluster 110, by capturing the traffic at the first network interface (or network stack) that is associated with the first container 140.

FIG. 5 illustrates an exemplary method 500 for capturing and transmitting packets from the capture client 145 to the data injector 135. The capture client includes well known tools and means for capturing packets such as TCPdump, and/or Wireshark At step 510, the capture client 145 detects the first connection for transmission of packets on the first network interface associated with the container 140. At step 520, the capture client 145 then transmits the network identifier of the first network interface to the data injector 135. The network identifier is used by the data injector 135 to determine the container information of the first container 140 associated with the first network interface based on the network catalogue from the cluster discovery service 310. At step 530, the capture client 145 captures packets on the first network interface.

In an embodiment, each capture client on a corresponding cluster, comprises a plurality of node capture services. Each node capture service is deployed on a corresponding node of the corresponding cluster associated with the capture client. Each node capture service is configured to monitor the corresponding node to detect or determine if connections from (or to) the containers on the corresponding node have been established. In an example, a node capture service detects whether a connection has been established by monitoring a plurality of sockets on the IP stacks associated with the containers on the corresponding node and the corresponding process table of the corresponding node. In an example, the node capture service may be based on existing network tools and network APIS, such as netstat, iproute2, and/or RTNETLINK API. Subsequent to the detection of a connection, the node capture service is configured to capture packets associated with the detected connection. In an example, the captured packets are then transmitted to the capture client.

At step 540, the capture client 145 next transmits the captured or duplicate packets as a packet stream to the data injector 135. In an example, the capture service provided by the capture client is at the container-specific virtual level (i.e., virtual network stack or network interface).

Subsequent to receiving the packets from the capture client 145, the data injector 135 modifies the packet stream by appending the container information of the first container to one or more packets of the packet stream and transmits the same to the packet capture tool 180.

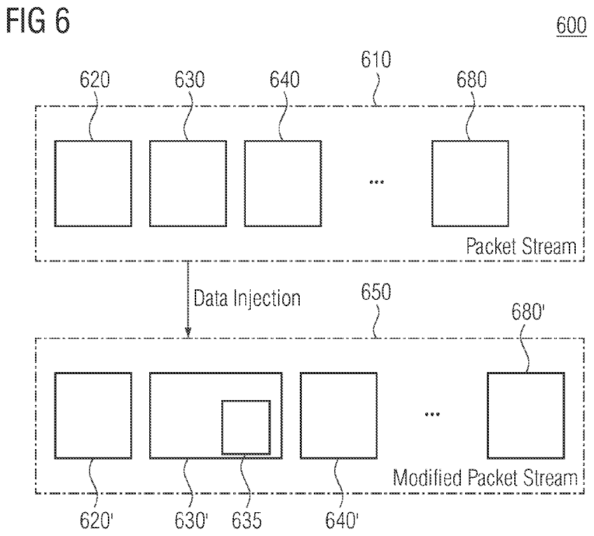

FIG. 6 illustrates an exemplary captured and modified packet streams 610 and 650 respectively. The captured packet stream 610 is transmitted from the capture client (for example, the capture client 145) to the data injector 135.

The captured packet stream 610 is composed of duplicate packets, captured on the first network interface in relation to the packets transmitted from container 140 to the container 130. In the example, the duplicate packets are transmitted in packet data format “PCAPNG” (Packet CAPture Next Generation Dump File Format). Accordingly, the data injector 135 determines a section header block of the PCAPNG file and appends the container information of the first container in the comments section of the section header block. For example, as shown in FIG. 6, the packet stream 610 from the capture client may include a plurality of packets (620-680) as a part of PCAPNG file. The data injector 135 parses each packet to see whether the packet includes the section header block. In the current case, the section header block is present in packet 630. If the packet does not contain the section header block, then the data injector 135 transmits the packet in its current form to the packet capture tool. This is the case for packets (620′, 640′-680′).

These packets are same as the packets 620, 640-680. The packet 630 is modified by appending the container information (635) to the comments section of the section header block and a new packet 630′ is generated by the data injector 135. The packet 630′ along with the other packets (620′, 640′-680′) is transmitted in the same sequence in which they were received from the capture client 145.

In an example, the appended container information includes an identifier of the container, an identifier of the node on which the container is hosted, an identifier of the cluster upon which the node is present and a type identifier indicative of the type of container the first container is. For example, the container information appended may be:

{
“container-meta” :
{
“name”: “default/foo”,
“type”: “pod”,
“node”: “node-42”,
“cluster-id”: “1234-56-78-9abc12305678”,
“cluster-name”: “clusterf”
}
}

As mentioned previously, in an example, the data injector may be realized within each cluster as a cluster specific data injector (as shown in FIG. 1). In an example, the data injector may be realized as a part of the capture client or the node capture service. In another example, the data injector may be realized as separate service, outside of any cluster (as shown in FIG. 3). The data injector acts like a proxy between the capture clients and the packet capture tool and injects container information. Additionally, while the above examples have been explained in reference to connections established for transmitting packets from a container, the current disclosure may also be applied to connections established for receiving packets at a container.

Additionally, the current disclosure is applicable to any data transmission wherein at least one entity involved in a container. The second entity may be a different container on the same cluster as the first container, a different container on a different cluster, and/or a different application outside of any clusters.

The present disclosure can take a form of a computer program product comprising program modules accessible from computer-usable or computer-readable medium storing program code for use by or in connection with one or more computers, processing units, or instruction execution system. For example, the data injector may be realized across one or more devices.

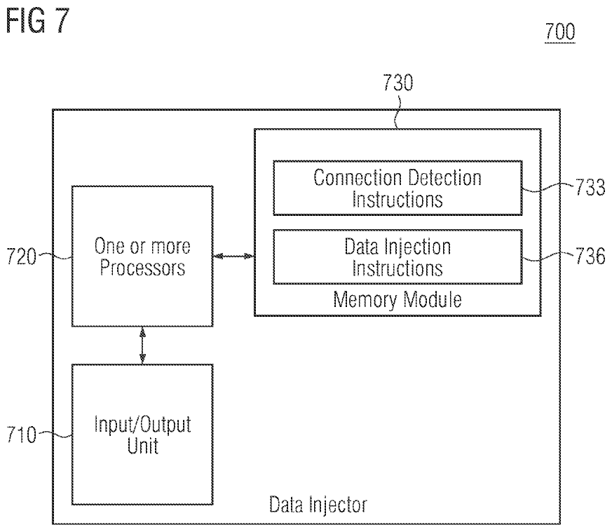

Accordingly, the current disclosure describes a data injector device 700 as shown in FIG. 7. The data injector device 700 includes an Input/Output (I/O) interface 710, one or more processors 720 and a non-transitory storage medium 730. The non-transitory storage medium 730 contains a plurality of instructions (733, and 736) for injecting container information in packet streams for packet capture.

Upon execution of the connection detection instructions 733, the one or more processors 720 in coordination with the one or more capture clients in the clusters monitor the network interfaces for a connection. When a connection is established from a container, the network interface is then identified via its network identifier. When the data injection instructions 736 are executed by the one or more processors 720, the duplicate packets in the packet stream from a capture client is injected with container information of the first container associated with the first network interface.

While the current disclosure describes the data injector 700 as an independent component or device, the data injector 700 may be a software component and may be realized within a network device or any other management device in the industrial network. For the purpose of this disclosure, a computer-usable or computer-readable non-transitory storage medium can be any apparatus that can contain, store, communicate, propagate, or transport the program for use by or in connection with the instruction execution system, apparatus, or device. The medium can be electronic, magnetic, optical, electromagnetic, infrared, or semiconductor system (or apparatus or device) or a propagation mediums in and of themselves as signal carriers are not included in the definition of physical computer-readable medium include a semiconductor or solid state memory, magnetic tape, a removable computer diskette, random access memory (RAM), a read only memory (ROM), a rigid magnetic disk and optical disk such as compact disk read-only memory (CD-ROM), compact disk read/write, and DVD. Both processing units and program code for implementing each aspect of the technology can be centralized or distributed (or a combination thereof) as known to those skilled in the art.

While the current disclosure is described with references to few industrial devices, a plurality of industrial devices may be utilized in the context of the current disclosure. While the present disclosure has been described in detail with reference to certain embodiments, it should be appreciated that the present disclosure is not limited to those embodiments. Additionally, while the current disclosure is explained in reference to containers, the term containers herein includes other similar execution environments such as pods in Kubernetes. In view of the present disclosure, many modifications and variations would be present themselves, to those skilled in the art without departing from the scope of the various embodiments of the present disclosure, as described herein. The scope of the present disclosure is, therefore, indicated by the following claims rather than by the foregoing description. All changes, modifications, and variations coming within the meaning and range of equivalency of the claims are to be considered within their scope. All advantageous embodiments claimed in method claims may also be applied to device/non transitory storage medium claims.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. A method for capturing packets originating from a first container from a cluster of containers, each container comprising at least one network interface for transmitting packets, the method comprising:
a) detecting a first connection for transmission of packets from a first network interface associated with a first container; and
b) injecting container information of the first container in a packet stream associated with the first connection, the injected container information serving for identification of the first container by a packet capture tool configured to capture the packet stream associated with the first connection; and
c) capturing, by the packet capture tool, the packet stream associated with the first connection;
wherein the container information is determined based on at least one network identifier of the first network interface and a container catalogue comprising container information of one or more containers; and
wherein container information of a container comprises a identifier of the container and one or more network identifiers of corresponding one or more network interfaces of the container.

10. The method as claimed in claim 9, wherein the network identifier of the first network interface includes at least one of a network namespace identifier, a process identifier of a process associated with the first container, media access control (MAC) identifier and an identifier associated with a IP stack of the network interface.

11. The method as claimed in claim 9, wherein the container catalogue is generated by a cluster discovery service; and wherein a cluster discovery service includes a plurality of node discovery modules, each node discovery module hosted on a corresponding node serving for discovering container and network interface information associated with the corresponding node.

12. The method as claimed in claim 9, wherein injecting container information further comprises identifying a first section header block in the packet stream associated with the first connection and appending the container information of the first container in a comment section of the first section header block.

13. The method as claimed in claim 9, wherein the first network interface is monitored by a capture client associated with the cluster.

14. A system for capturing packets from one or more containers in at least one cluster of containers, the system comprising:
a) a cluster discovery service hosted in the cluster of containers, the cluster discovery service being configured to discover the at least one containers in the cluster and generate a container catalogue;
b) a capture client hosted in the cluster of containers, the capture client being configured to transmit plurality of packets associated with the one or more containers in the cluster;
c) a data injector configured to receive plurality of packets from the capture client and inject container information of a corresponding container into at least one packet based on the container catalogue; and
d) a packet capture tool configured to record the plurality of packets, said the packet capture tool being further configured to identify the corresponding container based on the injected container information from one or more packets from the packet stream.

15. The system as claimed in claim 14, wherein the container catalogue comprises container information of one or more containers; and wherein container information of a container comprises a container identifier of the container and at least one network identifier of corresponding one or more network interfaces of the container.

16. A non-transitory storage medium for capturing packets originating from a first container from a cluster of containers, each container comprising at least one network interface for transmitting packets, the non-transitory storage medium having machine-readable instructions stored therein which, when executed by at least one processor, cause the at least one processor to:
a) detect a first connection for transmission of packets from a first network interface associated with the first container; and
b) inject container information of the first container in a packet stream associated with the first connection, the injected container information serving for identification of the first container by a packet capture tool configured to capture the packet stream associated with the first connection.
